(19) United States
(12) Patent Application Publication
(10) Pub. No.: US 2006/0100863 A1
(43) Pub. Date: May 11, 2006

(54) Process and computer program for management of voice production activity of a person-machine interaction system

(76) Inventors: Philippe Bretier, Trelevern (FR); Franck Panaget, Trebeurden (FR); David Sadek, Perros-Guirec (FR)

Correspondence Address: FISH & RICHARDSON P.C., PO BOX 1022, MINNEAPOLIS, MN, 55440-1022, US

(21) Appl. No.: 11/253,058

(22) Filed: Oct. 18, 2005

(30) Foreign Application Priority Data
Oct. 19, 2004 (FR) 0411092

(51) Int. Cl. G10L 11/06

(52) U.S. Cl. 704/214

(57) ABSTRACT

The invention especially concerns a management process of voice production activity of a person-machine interaction system with voice component, this process comprising operations consisting of exercising the voice production activity of the system, capturing external acoustic activity originating from an agent external to the system, and analyzing the semantic contents of any statement optionally included in the external acoustic activity. The process of the invention in addition comprises a detection operation consisting of detecting external acoustic activity during a period of voice production activity of the system, and a decision process consisting especially of interrupting the voice production activity of the system in the case where the time elapsed since the start of the external acoustic activity exceeds a first predetermined limited duration (P1) and/or in the case where the duration of the external acoustic activity exceeds a second predetermined limited duration (P2).

### CROSS REFERENCE TO RELATED APPLICATION

This application claims the benefit of French Application No. 0411092, filed Oct. 19, 2004, the contents of which are hereby incorporated by reference in its entirety.

### TECHNICAL FIELD

The present invention concerns, in general terms, the automation of communications processes.

More precisely, the invention concerns, according to a first of its aspects, a management process with voice production activity of a person-machine interaction system with vocal component, this process comprising operations consisting of exercising the activity of voice production of the system at least by producing statements, capturing external acoustic activity emanating from an agent external to the system, and analyzing the syntactic and semantic contents of any statement optionally included in the external acoustic activity.

### BACKGROUND

Person-machine interaction system with vocal component system is understood here to be any system having voice recognition functionality, and/or vocal synthesis, and/or voice message registration, and/or emission of voice statements, etc.

Voice services, in particular telephonic, and more generally all interactive systems for voice production, often offer functionality interactive voice systems often offer intervention functionality in force, known to the specialist under the English name “barge-in”, this functionality offering the user of such an interactive system the possibility of interrupting, via oral intervention, the voice production of this system (human voice or synthesis, real time or registered, music, noises, sound, etc.) to be able to formulate a request.

One of the interests of this functionality is to boost the efficacy of utilization of the system by reducing the duration of interaction and thus increasing the satisfaction of users. In particular, the users who interact regularly with the same system can thus interrupt certain reactions of the system, which they know already, since they have recognized the onset of said voice production. For example, a system recapitulating what it has understood of the user at the beginning of its reaction, allows the latter to rapidly detect a case of error in comprehension of the system, thus allowing him to correct it without reaching the end of the statement from the system.

In the case of face-to-face interaction between a user and a person-machine interaction system with voice component, the acoustic activity of the user and his environment is captured from the microphone of a desk or portable computer, a PDA or a UMTS terminal. The acquisition of the acoustic signal is often based on the utilization of a push button, in other words on a paradigm known to the specialist under the English name push-to-talk or walkie-talkie, and according to which the user must press a physical or virtual button (and optionally keep it pressed) while he speaks.

Conventionally, in a person-machine interaction system with voice component used over a telecommunications network or in a face-to-face interaction system not based on the push-to-talk paradigm, the interruption triggering condition is the detection of acoustic activity on the input voice channel of the system. This event is generally produced by a noise/word detection module when it detects strong energetic variation in the signal acoustic perceived on a reduced time window.

This acoustic activity can correspond to a voice statement of the user. In this case, the interruption is justified.

But this acoustic activity can optionally also correspond to a noise coming from the environment in which the user is situated (for example, vehicle or door noise, third party speech, etc.) or to an echo of the existence of the system (for example, in case of imperfection of the echo reducers present in the telecommunications networks or on the terminal equipment). In this case, the interruption mechanism is triggered where it did not have to be.

To decrease these interruption errors, certain person-machine interaction systems with voice component utilize the capacity to reject a word recognition component, coupled to the acoustic activity detection module, the function of which is the word recognitions pronounced by the user from the acoustic signal corresponding to the activity detected. For this, the word recognition module utilizes an acoustic-linguistic model describing the language “recognizable” by the system. This model can contain a reject model (or “dustbin” model) identifying the acoustic signal as a noise from the environment not corresponding to word production of the user. Accordingly, during voice production by the interaction system, after detection of acoustic activity, the interaction system waits until the recognition module identifies words of the language (that is, does not reject the acoustic activity) prior to being interrupted. If after detection of activity, the recognition module rejects it, the interaction system is not interrupted. But, of course, this supposes that the recognition result is calculable in real time, that is, a time not perceptible for the user.

Systems based on the push-to-talk paradigm are not subject to decision-making problems due to the fact that they receive an acoustic input signal only when the user presses on the button. However, the fact of requiring physical action of pressure on the button restricts the field of application of interaction systems with voice component, inter alia, in the case of applications for or during which the user is occupied by another activity.

### SUMMARY

In this context, the aim of the invention is to propose a management process of the voice production activity of a person-machine interaction system with voice component which is capable, without utilization of the push-to-talk paradigm, of interrupting the voice production activity of the system advisedly.

For this purpose, the inventive process, also according to the generic definition given by the preamble above, is essentially characterized in that it comprises in addition a detection operation consisting of detecting external acoustic activity at least during a period of voice production activity of the system, and a decision process consisting of at least interrupting the voice production activity of the system in the case where the time elapsed since the start of the external acoustic activity exceeds a first predetermined limited duration and/or in the case where the duration of the external acoustic activity exceeds a second predetermined limited duration.

The process of the invention preferably also comprises an overlap measuring operation consisting of measuring the overlap duration of external acoustic activity and of voice production activity of the system, the decision process further consisting of at least inhibiting interruption of the voice production activity of the system in the case where the duration of overlap is at most equal to a third limited duration, and/or in the case where the duration of the external acoustic activity attributable to a word time is at most equal to a fourth limited duration, and/or in the case where the external acoustic activity is not recognized as a carrier of a statement adapted to the interaction underway.

The first limited duration is advantageously greater than the second limited duration, and the fourth limited duration is advantageously less than the first and the second limited durations.

The invention also concerns a computer program for managing voice production activity of a person-machine interaction system with voice component, this program comprising a voice production or acoustic module responsible for the voice production activity of the system, a word detection module for surveilling the appearance of external acoustic activity originating from an agent external to the system, a word recognition module for recognizing the words (that is, the statement or syntactic content) optionally included in the external acoustic activity, and optionally an interpretation module for constructing the semantic content of the statement formed by these words, this program being characterized in that it comprises in addition an interruption decision module for detecting the appearance of external acoustic activity during a period of voice production activity of the system, and for interrupting the voice production activity of the system at least in the case where the time elapsed from the start of external acoustic activity exceeds a first predetermined limited duration and in the case where the duration of external acoustic activity exceeds a second predetermined limited duration.

The interruption decision module is preferably for measuring the duration of overlap of external acoustic activity and of voice production activity of the system, and inhibiting interruption of the voice production activity of the system in the case where the duration of overlap is at most equal to a third limited duration, and/or in the case where the duration of the external acoustic activity attributable to a word time is at most equal to a fourth limited duration, and/or in the case where the external acoustic activity is not recognized as a carrier of a statement adapted to the interaction underway.

Other characteristics and advantages of the invention will emerge clearly from the following description, by way of indication and in no way limiting, in reference to the attached diagrams, in which:

### DESCRIPTION OF DRAWINGS

FIG. 1 is a sketch illustrating a telephone link between a user and a person-machine interaction system with voice component;

FIG. 2 is a sketch illustrating a face-to-face link between a user and a person-machine interaction system with voice component;

FIG. 3 illustrates the components of a person-machine interaction system with voice component in telephone link with a user;

FIG. 4 is a sketch of interfacing of the interruption decision module according to the present invention with the known modules of a person-machine interaction system with voice component;

FIG. 5 is a status diagram of person-machine voice interaction as utilized in the invention;

FIG. 6 is a sketch chronologically illustrating organization of the main events flowing from acoustic activity of a user according to the invention; and

FIG. 7 is a diagram recapitulating the regulations and decisions made in the most complete form of the process according to the present invention.

### DETAILED DESCRIPTION

The aim of the invention, which applies to any person-machine interaction system with voice component, is to optimize ergonomy by allowing the user of such a system to interrupt, by oral intervention, voice production.

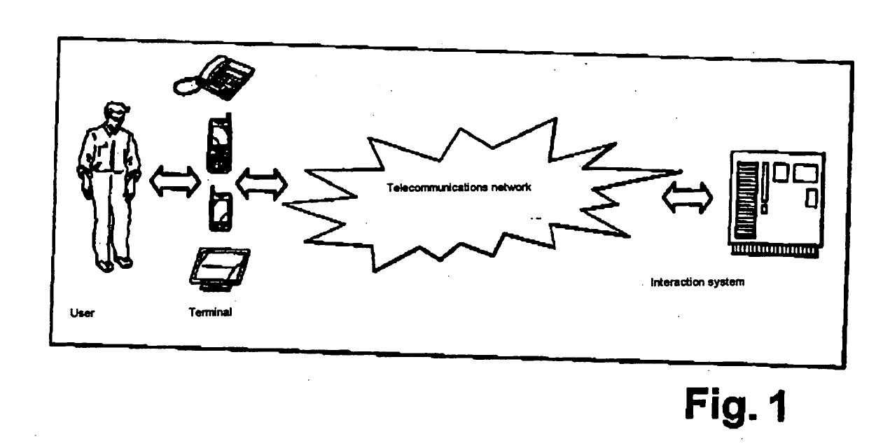

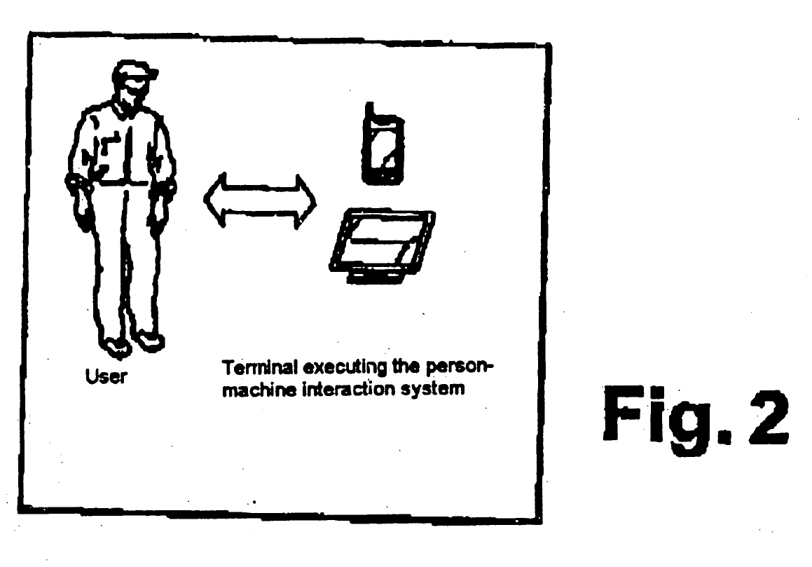

FIGS. 1 and 2 illustrate the use of such an interaction system, respectively in the case of a telephone link and a direct link.

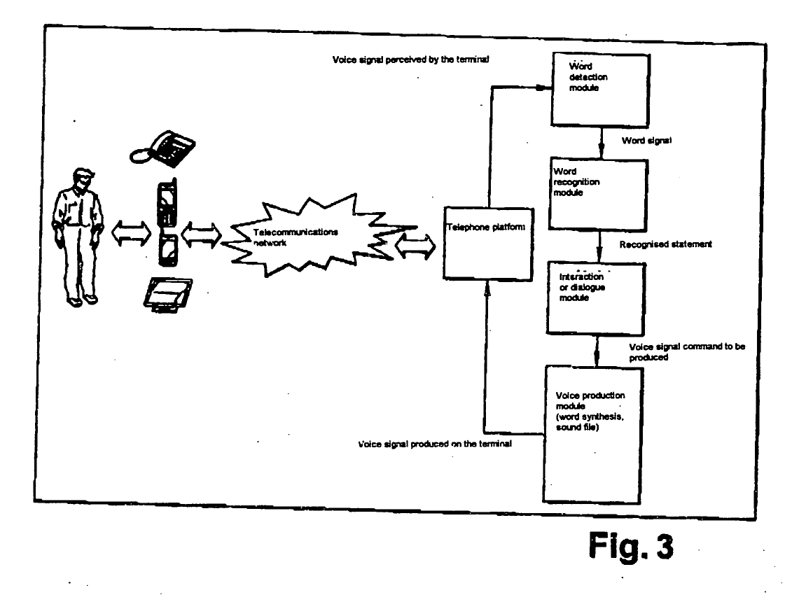

FIG. 3, which depicts in a more detailed manner the functional structure of a known interaction system and utilized for a telephone link, shows, apart from a telephone platform, a series of interconnected modules, comprising a word detection module, a word recognition module, an interaction or dialogue module, and a voice production module, utilizing for example word synthesis or sound file synthesis.

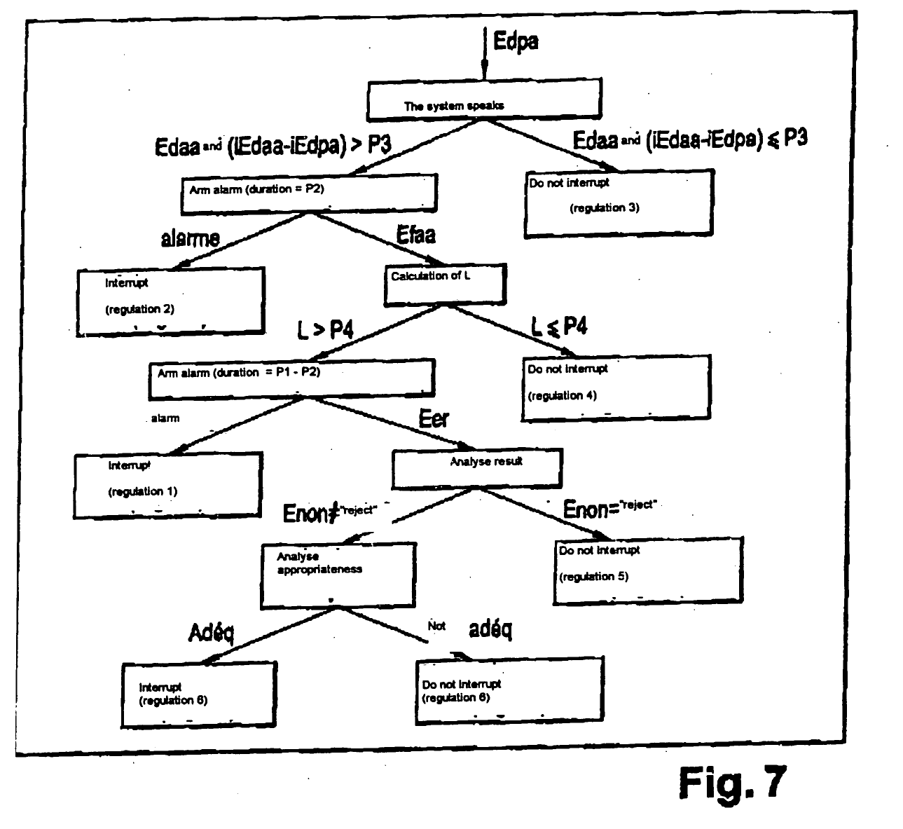

The solution offered by the invention consists overall of introducing, in such a system, an interruption decision module for interrupting voice production activity of the system according to certain hierarchical regulations, such as illustrated in FIG. 7.

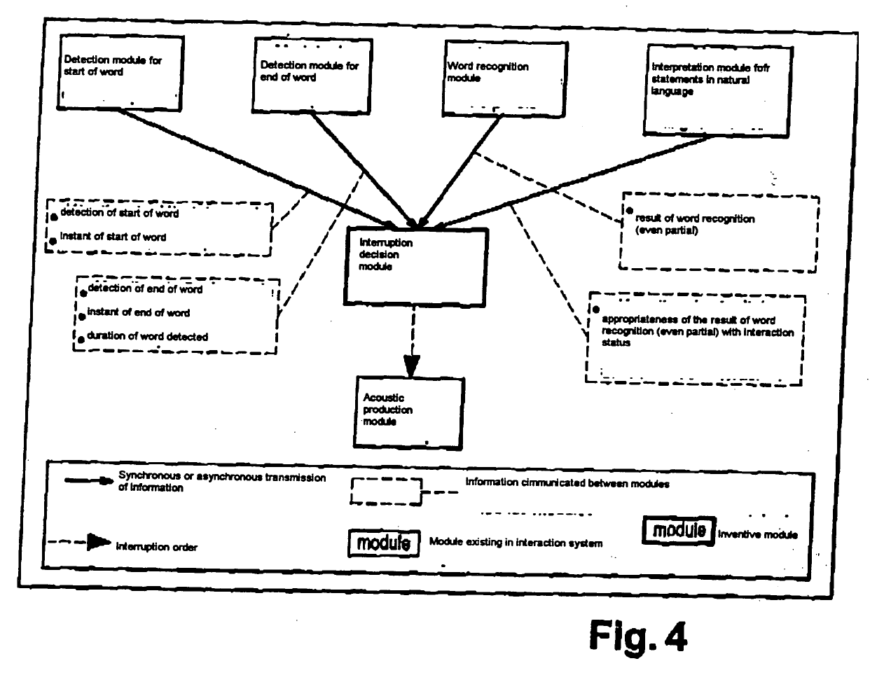

FIG. 4 illustrates and identifies the interactions maintained by this interruption decision module with the existing modules, the word detection module being supposed to decompose in a word start detection module and in a word finish detection module.

The constraints imposed on this decision interruption module are:
to contain the integrity of the interruption decision process;
to reduce erroneous interruption decisions, in other words to reduce interruptions due to the detection of different acoustic activity of a statement (recognizable, significant and destined for the interaction system) of the user, and
to eliminate the necessity of making use of the push-to-talk paradigm in face-to-face person-machine interaction applications.

Throughout the present description, time instants will be supposed expressed in milliseconds.

By way of agreement, “i” will designate the present instant (the “now”), and t(E) will designate the emission instant of a given event E.

The decision making is based on the exploitation of all or part of the following events:
the detection of the start of acoustic activity produced by the interaction system on its acoustic output channel, noted as Edpa (for start acoustic production event);
the detection of the end of acoustic activity produced by the interaction system on its acoustic output channel, noted as Efpa (for finish acoustic production event);
the detection of the start of the word or a significant acoustic event on the input acoustic channel (detected by the noise/word detector), noted as Edaa (for start acoustic acquisition event);
the detection of the end of the word or significant acoustic event on the input acoustic channel (detected by the noise/word detector), noted as Efaa (for end acoustic acquisition event);
the availability of the statement recognized by a word recognition module, noted as Eer (for recognized statement event);
the availability of the result of the appropriateness of the result (even partial) of word recognition with the status of person-machine interaction, noted as Era (for appropriateness result event).

Even though taking into account of this latter type of information, namely the appropriateness of the result of word recognition with the status of person-machine interaction, is specific to the invention, this information can be obtained in a manner known to the specialist by means of a module for interpretation of statements in natural language in context of person-machine interaction, such as described in the patent document FR 2 787 902 by the same applicant.

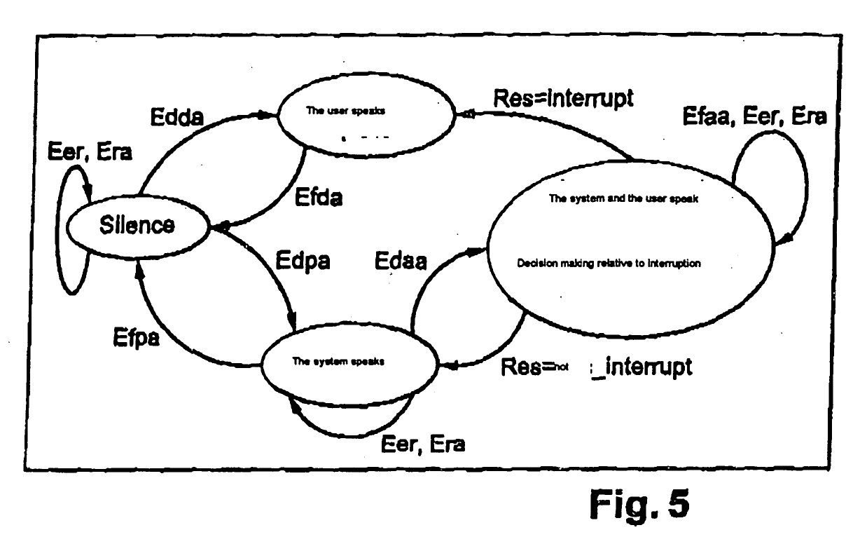

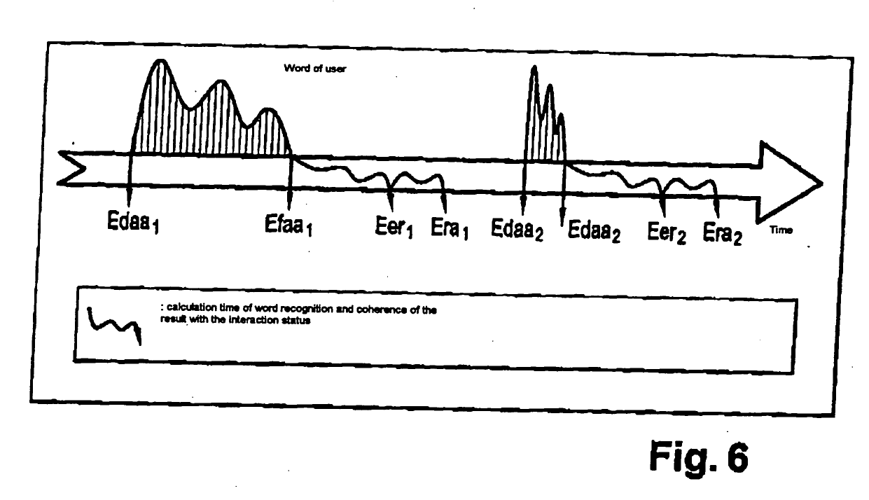

The different statuses which can be adopted by person-machine voice interaction within the scope of the invention are illustrated in FIG. 5. The chronology of the corresponding events is detailed in FIG. 6.

The decision making module also exploits the following information:
the duration, noted as L, of detection of the word or the significant acoustic activity. The duration L is calculated either directly by the noise/word detection module or by means of the following formula L=t(Efaa)−t(Edaa);
the statement (that is, the sequence de words) recognized by the word recognition module, noted as Enon;
and the result, noted as Adeq, of a boolean combination indicating whether the recognized statement is adequate (Adeq is then true) or not (Adeq is then false) relative to the status of interaction.

The result of the decision making module (noted as Res) is constituted either:
by interruption of the acoustic activity in the course of production by the interaction system (in this case, Res=interrupt),
or by the absence of interruption of acoustic activity during production by the interaction system (in this case, Res=not_interrupt). In this latter case, the recognized (and optionally interpreted) statement will not be taken into account by the interaction system.

The decision making of course intervenes solely when the system is in train realizing acoustic activity such as, for example, the emission of a statement or the broadcast of music, in other words the decision making module has received the event Edpa but not yet the event Efpa.

The decision making cannot exceed a period (of the order of three seconds) beyond which the “barge-in” becomes null and void (since beyond this period, the probability that this is the user interrupting is strong).

The decision making module must thus respect the following constraint:
t(Eer)−t(Edaa)≧P1,
the parameter P1 expressing the maximum period for taking an interruption decision.

Otherwise expressed, the decision making module must respect the following corollary:
Regulation 1: If i−t(Edaa)≦P1 then Res=interrupt,
the parameter P1 being typically selected such as: P1≦3000.

The results of word recognition and analysis of the statement recognized often intervene in a certain period after detection of the end of acoustic activity. It is therefore necessary to fix, by regulation 2 hereinbelow, a constraint on the maximum duration of the acoustic signal beyond which the system must be interrupted.
Regulation 2: If i−t(Edaa)≧P2 and if Efaa is not yet received, then RES=interrupt,
the parameter P2 being typically selected such that: P2≦1.

To reduce the erroneous interruptions especially due to the echo of the interaction system, the decision making module must also use the following regulation:
Regulation 3: If (t(Edaa)−t(Edpa)≦P3, then Res=not-interrupt,
the parameter P3 being typically selected such as: P3≦3000, this parameter P3 representing the period during which the interaction system is deaf when it begins voice production.

The perceived acoustic activity must have satisfactory duration to correspond with a statement, this constraint is expressed by the following regulation:
Regulation 4: If L≦P4 then Res=not_interrupt,
the parameter P4 being typically selected such as: P4≦200.

The word recognition modules utilize an acoustic-linguistic model of the language to be recognized. Certain of these models contain a reject model (or “dustbin” model). If the result of the recognition corresponds to this reject, the system does not have to be interrupted, this situation being taken into account by the following regulation:
Regulation 5: If Enoa=element of the “reject” model, then Res=not_interrupt.

The following regulation indicates that if the statement recognized is not in appropriateness with the status of interaction, the system is not interrupted:
Regulation 6: Res=not_interrupt if_and_only_if not Adeq.

The decision making module can utilize all or some of these six regulations.

The invention draws its advantages from utilization of a limited duration such as defined by regulation 1, a well as from utilization of the limited durations such as defined by regulations 2 to 4, from utilization of the result of appropriateness of regulation 6, and from the combination of this result with the other regulations.

The whole of the possible combinations is recapitulated in the table below, whereof each line corresponds to a variant, and in which the “X” indicate the regulations which have been utilized.

| Regula- | Regula- | Regula- | Regula- | Regula- | Regula- |
|---|---|---|---|---|---|
| tion 1 | tion 2 | tion 3 | tion 4 | tion 5 | tion 6 |
| | | X | | | |
| | | | X | | |
| | | X | X | | |
| X | | | | X | |
| X | X | | | X | |
| X | | | | X | X |
| X | X | | | X | X |
| X | | X | | X | |
| X | X | X | | X | |
| X | | X | | X | X |
| X | X | X | X | X | X |
| X | | | X | X | |
| X | X | | | | |
| X | | | | | X |
| X | X | | | | X |
| X | | X | X | X | |
| X | X | X | X | X | |
| X | | X | X | X | X |
| X | X | X | X | X | X |

A number of embodiments of the invention have been described. Nevertheless, it will be understood that various modifications may be made without departing from the spirit and scope of the invention. Accordingly, other embodiments are within the scope of the following claims.

What is claimed is:

1. A management process for voice production activity of a person-machine interaction system with voice component, this process comprising:
operations consisting of exercising the voice production activity of the system at least by producing statements, capturing external acoustic activity originating from an agent external to the system, and analyzing the syntactic and semantic contents of any statement optionally included in the external acoustic activity;
detecting external acoustic activity at least during a period of voice production activity of the system; and
decision process consisting of at least interrupting the voice production activity of the system in the case where the time elapsed from the start of the external acoustic activity exceeds a first predetermined limited duration (P1) and/or in the case where the duration of the external acoustic activity exceeds a second limited predetermined duration (P2).

2. The process as claimed in claim 1,
further comprising an operation for measuring overlap consisting of measuring the duration of overlap of the external acoustic activity and of the voice production activity of the system; and
wherein the decision process also consists at least of inhibiting interruption of the voice production activity of the system in the case where the duration of overlap is at most equal to a third limited duration (P3), and/or in the case where the duration of the external acoustic activity attributable to a word time is at most equal to a fourth limited duration (P4), and/or in the case where the external acoustic activity is not recognized as a carrier of a statement adapted to the interaction underway (regulation 5 or regulation).

3. The process as claimed in claim 2, wherein the first limited duration is greater than the second limited duration.

4. The process as claimed in claim 3, wherein the fourth limited duration is less than the first and the second limited durations.

5. The process as claimed in claim 1, wherein the first limited duration is greater than the second limited duration.

6. The process as claimed in claim 2, wherein the fourth limited duration is less than the first and the second limited durations.

7. A computer program which is suitable, when said program runs on a computer, for managing voice production activity of a person-machine interaction system with voice component, this program comprising:
a voice production or acoustic module responsible for the voice production activity of the system;
a module for word detection for surveilling the appearance of external acoustic activity originating from an agent external to the system;
a word recognition module for recognizing the words included in the external acoustic activity; and
an interruption decision module for detecting the appearance of external acoustic activity during a period voice production activity of the system, and for interrupting the voice production activity of the system at least in the case where the time elapsed since the start of the external acoustic activity exceeds a first predetermined limited duration and/or in the case where the duration of the external acoustic activity exceeds a second limited predetermined duration.

8. The computer program as claimed in claim 7, wherein, when said program runs on a computer, the interruption decision module is for measuring the duration of overlap of the external acoustic activity and of the voice production activity of the system, and inhibiting the interruption of the voice production activity of the system in the case where the overlap duration is at most equal to a third limited duration, and/or in the case where the duration of the external acoustic activity attributable to a word time is at most equal to a fourth limited duration, and/or in the case where the external acoustic activity is not recognized as a carrier of a statement adapted to the interaction underway.

9. The computer program as claimed in claim 8, wherein, when said program runs on a computer, the first limited duration (P1) is greater than the second limited duration (P2).

10. The computer program as claimed in claim 9, wherein, when said program runs on a computer, the fourth limited duration (P4) is less than the first (P1) and the second (P2) limited durations.

11. The computer program as claimed in claim 7, wherein, when said program runs on a computer, the first limited duration (P1) is greater than the second limited duration (P2).

12. The computer program as claimed in claim 11, wherein, when said program runs on a computer, the fourth limited duration (P4) is less than the first (P1) and the second (P2) limited durations.

13. The computer program as claimed in claim 8, wherein, when said program runs on a computer, the fourth limited duration (P4) is less than the first (P1) and the second (P2) limited durations.
